(19) United States
(12) Patent Application Publication
(10) Pub. No.: US 2022/0258737 A1
(43) Pub. Date: Aug. 18, 2022

(54) MAP GENERATION APPARATUS AND VEHICLE CONTROL APPARATUS

(71) Applicant: Honda Motor Co., Ltd., Tokyo (JP)

(72) Inventor: Tokitomo Ariyoshi, Wako-shi (JP)

(21) Appl. No.: 17/669,345

(22) Filed: Feb. 10, 2022

(30) Foreign Application Priority Data
Feb. 16, 2021 (JP) 2021-022406

(51) Int. Cl. B60W 30/18; G01C 21/00; B60W 60/00

(52) U.S. Cl. CPC B60W 30/18159; G01C 21/3815; B60W 2520/06; B60W 2555/60; B60W 2552/05; B60W 60/001

(57) ABSTRACT

A map generation apparatus includes a microprocessor configured to perform generating a map, based on a data detected by an in-vehicle detection unit configured to detect a situation around a subject vehicle in traveling, recognizing a traveling direction of the subject vehicle on the generated map, and generating a traffic light information on a traffic light installed at an intersection as an additional information for the generated map. The traffic light is an arrow-type traffic light configured to permit traveling in a direction indicated by an arrow signal light. The microprocessor is configured to perform the generating a traffic light information including generating the traffic light information, based on the direction indicated by the arrow signal light, detected by the detection unit, and the traveling direction of the subject vehicle recognized in the recognizing.

### CROSS-REFERENCE TO RELATED APPLICATION

This application is based upon and claims the benefit of priority from Japanese Patent Application No. 2021-022406 filed on Feb. 16, 2021, the content of which are incorporated herein by reference.

### BACKGROUND OF THE INVENTION

### Field of the Invention

This invention relates to a distance calculation apparatus configured to calculate a distance to an object around a vehicle and a vehicle position estimation apparatus configured to estimate a position of the vehicle.

### Description of the Related Art

As such an apparatus of this type, a conventionally known apparatus stores, as map information, information on an arrow-type traffic light installed at an intersection (see, for example, JP 2008-242986 A1). In the apparatus described in JP 2008-242986 A1, the arrow direction of each arrow signal light provided at an arrow-type traffic light and a travel lane corresponding to each arrow signal light are stored in association with each other, and driving support is provided with the use of this map information.

For example, in the case where an arrow-type traffic light is newly installed, however, it is difficult to reflect information on the association between an arrow signal light and a travel lane in map information at an early stage.

### SUMMARY OF THE INVENTION

An aspect of the present invention is a map generation apparatus including an in-vehicle detection unit configured to detect a situation around a subject vehicle in traveling and a microprocessor and a memory connected to the microprocessor. The microprocessor is configured to perform generating a map, based on a data detected by the in-vehicle detection unit, recognizing a traveling direction of the subject vehicle on the map generated in the generating a map, and generating a traffic light information on a traffic light installed at an intersection as an additional information for the map generated in the generating a map. The traffic light is an arrow-type traffic light configured to permit traveling in a direction indicated by an arrow signal light. The microprocessor is configured to perform the generating a traffic light information including generating the traffic light information, based on the direction indicated by the arrow signal light, detected by the detection unit, and the traveling direction of the subject vehicle recognized in the recognizing.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system according to the embodiment of the present invention;

FIG. 2A is a diagram illustrating an example of an intersection;

FIG. 2B is a front view of a traffic light;

FIG. 3 is a block diagram illustrating a main part configuration of a map generation apparatus according to an embodiment of the present invention; and

FIG. 4 is a flowchart illustrating an example of processing executed by the controller in FIG. 3.

### DETAILED DESCRIPTION

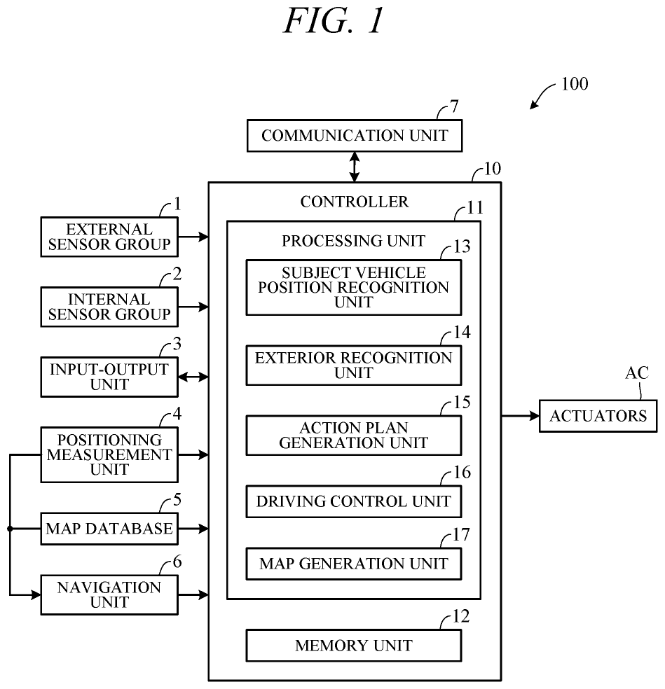

An embodiment of the present invention will be described below with reference to FIGS. 1 to 4. A map generation apparatus according to the embodiment of the present invention can be applied to a vehicle including a self-driving capability, that is, a self-driving vehicle. It is to be noted that a vehicle to which the map generation apparatus according to the present embodiment is applied may be referred to as a subject vehicle as distinguished from other vehicles. The subject vehicle may be any of an engine vehicle including an internal combustion (engine) as a traveling drive source, an electric vehicle including a traveling motor as a traveling drive source, and a hybrid vehicle including an engine and a traveling motor as a traveling drive source. The subject vehicle can travel not only in a self-drive mode in which a driving operation by a driver is unnecessary, but also in a manual drive mode by the driving operation by the driver.

First, a schematic configuration related to self-driving will be described. FIG. 1 is a block diagram schematically illustrating an overall configuration of a vehicle control system (vehicle control apparatus) 100 including a map generation apparatus according to the embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and a traveling actuator AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by irradiating with electromagnetic waves and detecting reflected waves, a camera that is mounted on the subject vehicle, has an imaging element such as a charge coupled device (CCD) or a complementary metal oxide semiconductor (CMOS), and images a periphery (forward, backward, and sideward) of the subject vehicle, and the like.

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolution of the traveling drive source, a yaw rate sensor that detects a rotation angular speed around a vertical axis of the center of gravity of the subject vehicle, and the like. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver via a display image, a speaker that provides information to the driver by voice, and the like.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses the positioning information received by the positioning sensor to measure a current position (latitude, longitude, and altitude) of the subject vehicle.

The map database 5 is a device that stores general map information used for the navigation unit 6, and is constituted of, for example, a hard disk or a semiconductor element. The map information includes road position information, information on a road shape (curvature or the like), and position information on intersections and branch points. The map information stored in the map database 5 is different from highly accurate map information stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated based on a current position of the subject vehicle measured by the position measurement unit 4 and the map information stored in the map database 5. The current position of the subject vehicle can be also measured with the used of the values detected by the external sensor group 1, and the target route may be calculated, based on the current position and the highly accurate map information stored in the memory unit 12.

The communication unit 7 communicates with various servers not illustrated via a network including wireless communication networks represented by the Internet, a mobile telephone network, and the like, and acquires the map information, traveling history information, traffic information, and the like from the server periodically or at an arbitrary timing. The network includes not only public wireless communication networks, but also a closed communication network provided for every predetermined management area, for example, a wireless local area network (LAN), Wi-Fi (registered trademark), Bluetooth (registered trademark), and the like. The acquired map information is output to the map database 5 and the memory unit 12, and the map information is updated.

The actuator AC is a traveling actuator for controlling the travel of the subject vehicle 101. In the case where the traveling drive source is an engine, the actuator AC includes therein a throttle actuator that adjusts the opening degree of a throttle valve (throttle opening degree) of the engine. In the case where the traveling drive source is a traveling motor, the actuator AC includes therein the traveling motor. The actuator AC also includes a brake actuator that operates a braking device of the subject vehicle and a steering actuator that drives a steering device.

The controller 10 includes an electronic control unit (ECU). More specifically, the controller 10 includes a computer that has a processing unit 11 such as a central processing unit (CPU) (microprocessor), a memory unit 12 such as a read only memory (ROM) and a random access memory (RAM), and other peripheral circuits (not illustrated) such as an input/output (I/O) interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as highly accurate map information). The highly accurate map information includes road position information, information of a road shape (curvature or the like), information of a road gradient, position information of an intersection or a branch point, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface. The highly accurate map information stored in the memory unit 12 includes map information acquired from the outside of the subject vehicle via the communication unit 7, for example, information of a map (referred to as a cloud map) acquired via a cloud server, and information of a map created by the subject vehicle itself using detection values by the external sensor group 1, for example, information of a map (referred to as an environmental map) including point cloud data generated by mapping using a technology such as simultaneous localization and mapping (SLAM). The memory unit 12 also stores information on such as various control programs and a threshold used in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes the position (subject vehicle position) of the subject vehicle on a map, based on the position information of the subject vehicle, obtained by the position measurement unit 4, and the map information of the map database 5. The subject vehicle position may be recognized using the map information stored in the memory unit 12 and the peripheral information of the subject vehicle detected by the external sensor group 1, whereby the subject vehicle position can be recognized with high accuracy. When the subject vehicle position can be measured by a sensor installed on the road or outside a road side, the subject vehicle position can be recognized by communicating with the sensor via the communication unit 7.

The outside exterior environment recognition unit 14 recognizes an external situation around the subject vehicle, based on the signal from the external sensor group 1 such as a LiDAR, a radar, and a camera. For example, the position, speed, and acceleration of a surrounding vehicle (a forward vehicle or a rearward vehicle) traveling around the subject vehicle, the position of a surrounding vehicle stopped or parked around the subject vehicle, and the positions and states of other objects are recognized. Other objects include signs, traffic lights, markings such as division lines and stop lines of roads, buildings, guardrails, utility poles, signboards, pedestrians, bicycles, and the like. The states of other objects include a color of a traffic light (red, green, yellow), the moving speed and direction of a pedestrian or a bicycle, and the like.

The action plan generation unit 15 generates a driving path (target path) of the subject vehicle from a current point of time T to a predetermined time ahead based on, for example, the target route calculated by the navigation unit 6, the subject vehicle position recognized by the subject vehicle position recognition unit 13, and the external situation recognized by the exterior environment recognition unit 14. When there are a plurality of paths that are candidates for the target path on the target route, the action plan generation unit 15 selects, from among the plurality of paths, an optimal path that satisfies criteria such as compliance with laws and regulations and efficient and safe traveling, and sets the selected path as the target path. Then, the action plan generation unit 15 generates an action plan corresponding to the generated target path. The action plan generation unit 15 generates various action plans corresponding to traveling modes, such as overtaking traveling for overtaking a preceding vehicle, lane change traveling for changing a travel lane, following traveling for following a preceding vehicle, lane keeping traveling for keeping the lane so as not to deviate from the travel lane, deceleration traveling, or acceleration traveling. When the action plan generation unit 15 generates the target path, the action plan generation unit 15 first determines a travel mode, and generates the target path based on the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuator AC is feedback controlled so that an actual acceleration detected by the internal sensor group 2 becomes the target acceleration. More specifically, the actuator AC is controlled so that the subject vehicle travels at the target vehicle speed and the target acceleration. In the manual drive mode, the driving control unit 16 controls each of the actuators AC in accordance with a travel command (steering operation or the like) from the driver acquired by the internal sensor group 2.

The map generation unit 17 generates the environmental map constituted by three-dimensional point cloud data using detection values detected by the external sensor group 1 during traveling in the manual drive mode. Specifically, an edge indicating an outline of an object is extracted from a captured image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 sequentially plots the extracted feature points on the environmental map, thereby generating the environmental map around the road on which the subject vehicle has traveled. The environmental map may be generated by extracting the feature point of an object around the subject vehicle with the use of data acquired by radar or LiDAR instead of the camera.

The subject vehicle position recognition unit 13 performs subject vehicle position estimation processing in parallel with map creation processing by the map generation unit 17. More specifically, the position of the subject vehicle on the map (environmental map) is estimated based on a change in the position of the feature point over time. The map creation processing and the position estimation processing are simultaneously performed, for example, according to an algorithm of SLAM. The map generation unit 17 can generate the environmental map not only when the vehicle travels in the manual drive mode but also when the vehicle travels in the self-drive mode. If the environmental map has already been generated and stored in the memory unit 12, the map generation unit 17 may update the environmental map with a newly obtained feature point.

Now, when an arrow-type traffic light installed at an intersection is provided with a plurality of arrow signal lights, with the directions indicated by the respective arrow signal lights close to each other, it is difficult to recognize roads (travel lanes) corresponding to the respective arrow signal lights. In particular, the number of arrow signal lights provided at the arrow signal lights is increased at the intersection of multi-forked roads, thus making it more difficult to determine the roads corresponding to the respective arrow signal lights.

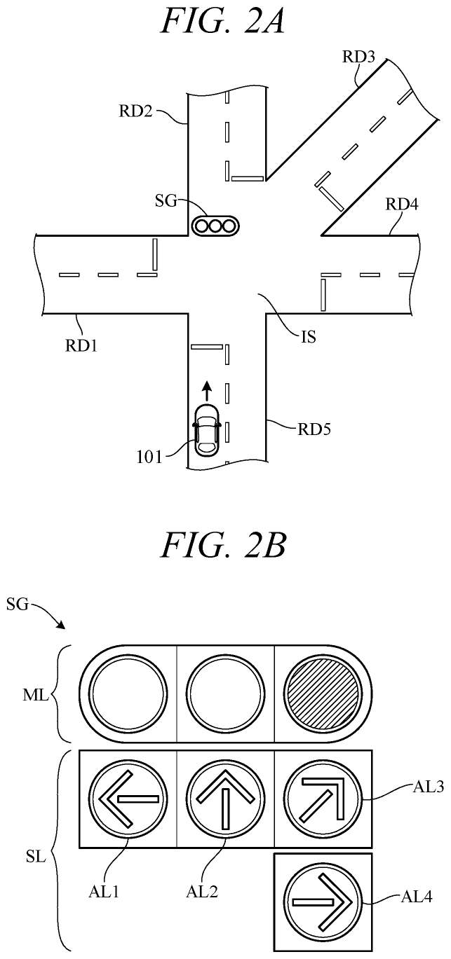

FIG. 2A illustrates an exemplary intersection. The intersection IS of FIG. 2A is a five-forked road where roads RD1 to RD5 cross with one lane on one side of left-hand traffic. Traffic lights corresponding to the respective roads are each installed at the intersection IS. It is to be noted that the traffic lights other than a traffic light SG corresponding to the road RD5 are omitted in FIG. 2A for simplification of the drawing. FIG. 2B is a front view of the traffic light SG corresponding to the road RD5 on which a subject vehicle 101 travels. As illustrated in FIG. 2B, the traffic light SG includes: a main traffic light section ML configured such that a display mode can be switched among a green color indicating forward movement permission, a red color indicating a stop instruction at the road stop line, and a yellow color indicating a notice of switching from the green color to the red color; and an auxiliary signal section SL that has four arrow signal lights AL1 to AL4. While the arrow signal lights AL1 to AL4 of the auxiliary signal section SL are lit (lit in green), the vehicle is permitted to travel to the travel lanes (roads RD1 to RD4) that run in the directions indicated by the arrow signal lights AL1 to AL4. In that case, when the directions indicated by the respective arrow signal lights are close to each other as with the arrow signal lights AL2, AL3, and AL4 in FIG. 2B, there is a possibility that the corresponding travel lanes may be erroneously recognized. For example, there is a possibility that the travel lane corresponding to the arrow signal light AL2 may be erroneously recognized as the road RD3, or the travel lane corresponding to the arrow signal light AL3 may be erroneously recognized as the road RD4.

In this regard, there is a method of causing the memory unit 12 to store in advance, as map information, information on the arrow-type traffic lights installed at intersection, specifically, information (hereinafter, referred to as traffic light information) that associates each arrow signal light with the road (travel lane) corresponding to each arrow signal light. Such a method is capable of preventing the arrow signal lights from being erroneously recognized. In the case where the traffic light information is stored in advance, however, a discrepancy may be created between an actual road situation and the map information when an arrow-type traffic light is newly installed or when the road structure at the intersection is changed. In such a case, there is a possibility that the driving support with the map information used may be inappropriately provided. Thus, for dealing with such a problem, a road information generation device is configured as follows according to the present embodiment.

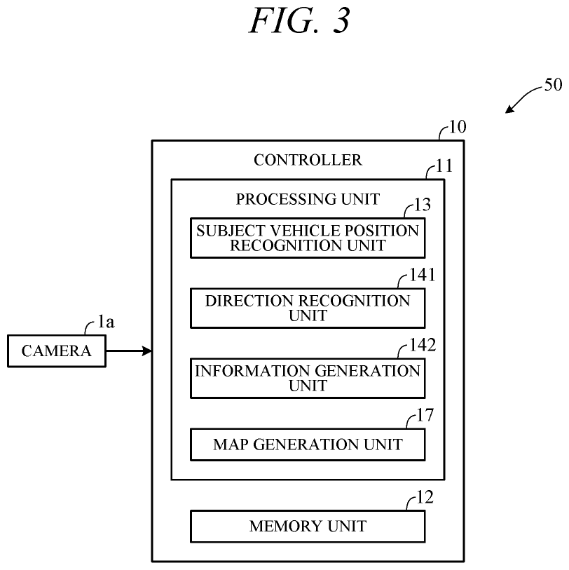

FIG. 3 is a block diagram illustrating a main part configuration of a map generation apparatus 50 according to an embodiment of the present invention. The map generation apparatus 50 generates road information that associates an arrow signal light with a travel lane corresponding to the arrow signal light, and constitutes a part of the vehicle control system 100 of FIG. 1. As illustrated in FIG. 3, the map generation apparatus 50 includes the controller 10 and a camera 1a.

The camera 1a is a monocular camera having an imaging element (image sensor) such as a CCD or a CMOS, and constitutes a part of the external sensor group 1 in FIG. 1. The camera 1a may be a stereo camera. The camera 1a images the surroundings of the subject vehicle 101. The camera 1 a is mounted at a predetermined position, for example, in front of the subject vehicle 101, and continuously captures an image of a space in front of the subject vehicle 101 to acquire an image (captured image) of the object.

The map generation apparatus 50 includes, as a functional configuration undertaken by the processing unit 11, the map generation unit 17, a direction recognition unit 141, and an information generation unit 142. The direction recognition unit 141 and the information generation unit 142 are constituted by, for example, the exterior environment recognition unit 14 in FIG. 1. It is to be noted that the information generation unit 142 may be constituted by the map generation unit 17. In the memory unit 12 in FIG. 3, captured images acquired by the camera 1a are stored as described later.

The map generation unit 17 generates the environmental map constituted by a map around the subject vehicle 101, that is, the environmental map constituted by three-dimensional point cloud data, based on the captured image acquired by the camera 1a during traveling in the manual drive mode. The generated environmental map is stored in the memory unit 12. When generating the environmental map, the map generation unit 17 determines whether or not a landmark such as a traffic light, a sign, or a building as a mark on the map is included in the captured image by, for example, pattern matching processing. When it is determined that the landmark is included, the position and the type of the landmark on the environmental map are recognized based on the captured image. The landmark information is stored on or added to the environmental map and stored in the memory unit 12.

The direction recognition unit 141 recognizes the traveling direction of the subject vehicle 101 on the map (environmental map) generated by the map generation unit 17. More specifically, the direction recognition unit 141 recognizes the traveling direction of the subject vehicle 101 when the subject vehicle 101 passes through the intersection where the arrow-type traffic light is installed. For example, when the subject vehicle 101 in FIG. 2A travels to the roads RD1, RD2, RD3, and RD4 after passing through the intersection IS, the direction recognition unit 141 recognizes traveling directions when the subject vehicle 101 passes through the intersection respectively as a “leftward direction”, a “straight direction”, an “oblique rightward direction”, and a “rightward direction.” In that case, the direction recognition unit 141 recognizes the traveling direction when the subject vehicle 101 passes through the intersection, based on the steering angle of the steering wheel, detected by the steering angle sensor of the internal sensor group 2. It is to be noted that the method of recognizing the traveling direction when the subject vehicle 101 passes through the intersection is not limited thereto. For example, the direction recognition unit 141 may recognize the traveling direction when the subject vehicle 101 passes through the intersection, based on the transition of the subject vehicle position on the environmental map recognized by the subject vehicle position recognition unit 13. More specifically, the map generation apparatus 50 may include, as illustrated in FIG. 3, the subject vehicle position recognition unit 13 as a functional configuration undertaken by the processing unit 11 (FIG. 1).

The information generation unit 142 generates information (traffic light information) about the arrow-type traffic light installed at the intersection as additional information for the map generated by the map generation unit 17. First, in the case where the intersection is included in the captured image acquired by the camera 1a, the information generation unit 142 detects, based on the captured image, the direction (hereinafter, referred to as indicated direction or arrow direction) indicated by each arrow signal light of the arrow-type traffic light installed at the intersection in accordance with, for example, processing of pattern matching. The indicated direction is the direction of the arrow of the arrow signal light with respect to the vertical direction, which is detected when the traffic light is viewed from the front. It is to be noted that, when the traffic light included in the captured image acquired by the camera 1a does not face the front, the information generation unit 142 geometrically converts (rotates or the like) the arrow of the arrow signal light on the captured image to acquire (detect) the direction of the arrow of the arrow signal light when the traffic light is viewed from the front. It is to be noted that the method for detecting the indicated direction of the arrow signal light is not limited thereto.

Then, the information generation unit 142 calculates the angle of the indicated direction of each arrow signal light with respect to the vertical direction. For example, the angles of the indicated directions of the arrow signal lights AL1, AL2, AL3, and AL4 in FIG. 2B are calculated respectively as −90 degrees, 0 degrees, 45 degrees, and 90 degrees with respect to the vertical direction. In addition, the information generation unit 142 calculates the angle of the traveling direction of the subject vehicle 101, recognized by the direction recognition unit 141, more specifically, the angle of the traveling direction of the subject vehicle 101 after passing through the intersection with respect to the traveling direction before passing through the intersection. For example, when the subject vehicle 101 in FIG. 2A travels to the roads RD1, RD2, RD3, and RD4 after passing through the intersection IS, the angles of the traveling direction of the subject vehicle 101 are calculated respectively as −90 degrees, 0 degrees, 45 degrees, and 90 degrees.

Furthermore, the information generation unit 142 generates information (traffic light information) that associates the travel lane of the subject vehicle 101 after passing through the intersection with the indicated direction of the arrow signal light as additional information for the map, and stores the additional information in the memory unit 12. For example, when the subject vehicle 101 in FIG. 2A travels to the road RD3 after passing through the intersection IS, traffic light information that associates information (for example, an identifier) on the road RD3 with information (for example, an identifier) on the arrow signal light AL3 whose angle of the indicated direction coincides with the angle of the traveling direction is generated as the additional information for the map. It is to be noted that when there is no arrow signal light whose angle of the indicated direction coincides with the angle of the traveling direction, information that associates the information on the travel lane with the information on the arrow signal light whose angle of the indicated direction is closest to the angle of the traveling direction may be generated as the traffic light information.

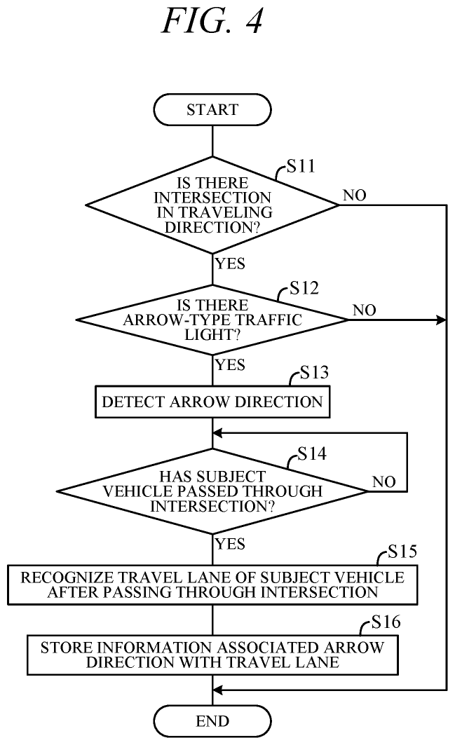

FIG. 4 is a flowchart illustrating an example of processing executed by the controller 10 in FIG. 3 in accordance with a predetermined program. The processing illustrated in the flowchart is started, for example when the controller 10 is powered on.

First, in step S11, based on a captured image of the front of the subject vehicle 101 in the traveling direction thereof, acquired by the camera 1a, whether an intersection is recognized or not, that is, whether the intersection is included in the captured image or not is determined. If the determination is negative in step S11, the processing ends. If the determination is affirmative in step S11, whether any arrow-type traffic light is installed at the intersection recognized in step S11 or not is determined, based on the captured image acquired in step S11, in step S12. If the determination is negative in step S12, the processing ends. If the determination is affirmative in step S12, the indicated direction (the direction of the arrow) of each arrow signal light of the arrow-type traffic light is detected in step S13. More specifically, the angle of the indicated direction of each arrow signal light of the arrow-type traffic light with respect to the vertical direction is detected. Then, whether the subject vehicle 101 has passed through the intersection recognized in step S11 or not is determined in step S14. Step S14 is repeated until the determination is affirmed. If the determination is affirmative in step S14, the traveling direction of the subject vehicle 101, that is, the travel lane of the subject vehicle 101 after passing through the intersection is recognized in step S15. Finally, an arrow signal light whose angle of the indicated direction detected in step S13 coincides with the angle of the traveling direction recognized in step S15 is selected in step S16. Then, traffic light information that associates information on the selected arrow signal light with information on the travel lane recognized in step S15 is generated, and the generated traffic light information is stored in the memory unit 12 as additional information for the map. When the processing ends, the processing is repeated from step S11 at predetermined time intervals.

The operation of the map generation apparatus 50 according to the present embodiment will be described more specifically. For example, when the subject vehicle 101 traveling on the road RD5 in FIG. 2A in the manual drive mode passes through the intersection IS in accordance with the arrow-type traffic light SG installed at the intersection IS and travels to the road RD4, traffic light information that associates information on the travel lane (road RD4) after passing through the intersection with information on an arrow signal light (arrow signal light AL4) whose angle of the traveling direction coincides with the angle of the indicated direction is stored in the memory unit 12 as additional information for the environmental map (S15, S16). As described above, the traffic light information is generated when the subject vehicle 101 passes through the intersection where the arrow-type traffic light is installed, thereby allowing traffic light information corresponding to the current road situation to be reflected in the map information at an early stage.

Thereafter, when the subject vehicle 101 travels by self-driving along the same route with the use of the environmental map, that is, travels a route by self-driving such that the subject vehicle turns right at the intersection IS from the road RD5 and then travels to the road RD4, the action plan generation unit 15 generates an action plan in accordance with the arrow signal light AL4 associated with the travel lane (road RD4), based on the traffic light information stored in the memory unit 12, when the arrow-type traffic light SG is recognized ahead in the traveling direction by the exterior environment recognition unit 14. For example, when the arrow signal light AL4 is turned off, the action plan generation unit 15 generates an action plan such that the subject vehicle 101 stops at the stop line of the intersection IS. In addition, for example, when the arrow signal light AL4 is turned on (lit in green), the action plan generation unit 15 generates an action plan such that the subject vehicle 101 turns right at the intersection IS and travels to the road RD4.

Similarly, when the subject vehicle 101 traveling in the manual drive mode travels straight from the road RD5 through the intersection IS to the road RD2, traffic light information that associates the identifier of the road RD2 with the identifier of the arrow signal light AL2 is stored in the memory unit 12 (S15, S16). Thereafter, when the subject vehicle 101 travels by self-driving along the same route with the use of the environmental map, the action plan generation unit 15 generates an action plan in accordance with the arrow signal light AL2 associated with the travel lane (road RD2). Thus, during traveling in the self-drive mode, in the case of entering an intersection where an arrow-type traffic light provided with a plurality of arrow signal lights is installed, such as the traffic light SG in FIG. 2B, the arrow signal light corresponding to the travel lane after passing through the intersection can be appropriately recognized, and safer driving support can be provided. Accordingly, safer appropriate traveling by self-driving can be achieved.

It is to be noted that an example of providing driving support by generating the action plan in accordance with the arrow signal light corresponding to the travel lane after passing through the intersection has been described above assuming traveling in the self-drive mode, but driving support can be provided with the use of the traffic light information in the case of traveling in the manual drive mode. In this case, the configuration may be such that traffic light information is reported. For example, an image with the traffic light information superimposed on the image of the arrow-type traffic light may be displayed on a display (not illustrated) of the navigation unit 6. More specifically, an image of such an arrow-type traffic light as illustrated in FIG. 2B may be displayed on the display of the navigation unit 6, and based on the traffic light information, the area of the arrow signal light to be recognized by the subject vehicle 101 may be highlighted (for example, displayed by surrounding with a red line).

According to the embodiment of the present invention, the following advantageous effects can be obtained:

(1) The map generation apparatus 50 includes: the camera 1a that detects a situation around the traveling subject vehicle 101; the map generation unit 17 that generates a map (environmental map), based on detected data (captured image) detected by the camera 1a; the direction recognition unit 141 that recognizes the traveling direction of the subject vehicle 101 on the map generated by the map generation unit 17; and the information generation unit 142 that generates traffic light information on a traffic light (arrow-type traffic light that permits traveling in the direction indicated by an arrow signal light) installed at an intersection as additional information for the map generated by the map generation unit 17. The information generation unit 142 generates traffic light information, based on the direction indicated by the arrow signal light, detected by the camera 1a, and the traveling direction of the subject vehicle 101 recognized by the direction recognition unit 141. Thus, traffic light information corresponding to the current road situation can be reflected in the map information at an early stage.

(2) When the traffic light has a plurality of arrow signal lights, the information generation unit 142 selects an arrow signal light corresponding to the traveling direction of the subject vehicle 101 from among the plurality of arrow signal lights, based on the direction indicated by each of the plurality of arrow signal lights, and generates, as the traffic light information, information that associates the selected arrow signal light with the traveling direction of the subject vehicle 101. Specifically, the information generation unit 142 selects, from among the plurality of arrow signal lights, the arrow signal light whose arrow direction coincides with the traveling direction of the subject vehicle 101 after passing through the intersection. It is to be noted that when there is no arrow signal light whose arrow direction coincides with the traveling direction of the subject vehicle 101 after passing through the intersection among the plurality of arrow signal lights, the information generation unit 142 selects the arrow signal light that indicates the direction closest to the traveling direction of the subject vehicle 101 after passing through the intersection. The information generation unit 142 generates, as traffic light information, information that associates the selected arrow signal light with the traveling direction of the subject vehicle 101 after passing through the intersection. Thus, traffic light information can be also generated for an arrow-type traffic light provided with a plurality of arrow signal lights, such as the traffic light SG in FIG. 2B.

(3) The vehicle control apparatus 100 includes: the map generation apparatus 50; and the action plan generation unit 15 that generates an action plan corresponding to the target path of the subject vehicle 101 when the subject vehicle 101 travels by self-driving. The action plan generation unit 15 generates an action plan, based on traffic light information about an arrow-type traffic light, generated by the map generation apparatus 50, when there is, on the target path, an intersection at which the arrow-type traffic light that permits traveling in the direction indicated by the arrow signal light is installed. Thus, it is possible to appropriately pass through the intersection in accordance with the arrow signal light, and safer driving support can be provided. Accordingly, safer appropriate traveling by self-driving can be achieved.

The above embodiment may be modified into various forms. Hereinafter, some modifications will be described. According to the embodiment mentioned above, the camera 1a is configured to detect the situation around the traveling subject vehicle, however, the configuration of the in-vehicle detector is not limited to the above-described configuration as long as the situation around the traveling subject vehicle is detected for map generation. More specifically, the in-vehicle detector may be a detector other than the camera. In addition, according to the embodiment mentioned above, the map generation unit 17 is configured to generate the environmental map while the subject vehicle travels in the manual drive mode, however, the map generation unit 17 may be configured to generate the environmental map while the subject vehicle travels in the self-drive mode.

In addition, according to the embodiment mentioned above, the information generation unit 142 is configured to generate, as the traffic light information, information that associates each arrow signal light with a road (travel lane) corresponding to each arrow signal light, however, the configuration of the map generation unit is not limited thereto. For example, the map generation unit may weight the traffic light information. More specifically, for the traffic light information, a weighting coefficient may be generated, based on the number of times when each travel lane is recognized in the past as a travel lane corresponding to each arrow signal light, and the weighting coefficient may be included in the traffic light information. Accordingly, the traffic light information can be generated with higher accuracy.

The present invention also can be configured as a map generation method including generating a map, based on a data detected by an in-vehicle detection unit configured to detect a situation around a subject vehicle in traveling, recognizing a traveling direction of the subject vehicle on the map generated in the generating a map; and generating a traffic light information on a traffic light installed at an intersection as an additional information for the map generated in the generating a map. The traffic light is an arrow-type traffic light configured to permit traveling in a direction indicated by an arrow signal light. The generating a traffic light information includes generating the traffic light information, based on the direction indicated by the arrow signal light, detected by the detection unit, and the traveling direction of the subject vehicle recognized in the recognizing.

The present invention can reflect information on the association between the arrow signal light of the arrow-type traffic light and the travel lane in the map information at an early stage.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
an in-vehicle detection unit configured to detect a situation around a subject vehicle in traveling; and
a microprocessor and a memory connected to the microprocessor, wherein
the microprocessor is configured to perform:
generating a map, based on a data detected by the in-vehicle detection unit;
recognizing a traveling direction of the subject vehicle on the map generated in the generating a map; and
generating a traffic light information on a traffic light installed at an intersection as an additional information for the map generated in the generating a map, wherein
the traffic light is an arrow-type traffic light configured to permit traveling in a direction indicated by an arrow signal light, and
the microprocessor is configured to perform the generating a traffic light information including generating the traffic light information, based on the direction indicated by the arrow signal light, detected by the detection unit, and the traveling direction of the subject vehicle recognized in the recognizing.

2. The map generation apparatus according to claim 1, wherein
the microprocessor is configured to further perform
when the traffic light has a plurality of arrow signal lights, selecting an arrow signal light corresponding to the traveling direction of the subject vehicle from among the plurality of arrow signal lights, based on the direction indicated by each of the plurality of arrow signal lights, and
the generating a traffic light information including generating, as the traffic light information, an information associated the arrow signal light selected in the selecting with the traveling direction of the subject vehicle.

3. The map generation apparatus according to claim 2, wherein
the microprocessor is configured to perform
the selecting includes selecting, from among the plurality of arrow signal lights, the arrow signal light whose arrow direction coincides with the traveling direction of the subject vehicle after passing through the intersection, and
the generating a traffic light information includes generating, as the traffic light information, an information associated the arrow signal light selected in the selecting with the traveling direction of the subject vehicle after passing through the intersection.

4. The map generation apparatus according to claim 3, wherein
the microprocessor is configured to perform
the selecting including when there is no arrow signal light whose arrow direction coincides with the traveling direction of the subject vehicle after passing through the intersection among the plurality of arrow signal lights, selecting the arrow signal light whose arrow direction is closest to the traveling direction of the subject vehicle after passing through the intersection.

5. A vehicle control apparatus configured to control an actuator for traveling so that a subject vehicle travels along a target path, the vehicle control apparatus comprising:
an in-vehicle detection unit configured to detect a situation around a subject vehicle in traveling;
a microprocessor and a memory connected to the microprocessor, wherein
the microprocessor is configured to perform:
generating a map, based on a data detected by the in-vehicle detection unit;
recognizing a traveling direction of the subject vehicle on the map generated in the generating a map;
generating a traffic light information on a traffic light installed at an intersection as an additional information for the map generated in the generating a map; and
generating an action plan corresponding to the target path of the subject vehicle when the subject vehicle travels in a self-driving mode, wherein
the traffic light is an arrow-type traffic light configured to permit traveling in a direction indicated by an arrow signal light, and
the microprocessor is configured to perform
the generating a traffic light information including generating the traffic light information, based on the direction indicated by the arrow signal light, detected by the detection unit, and the traveling direction of the subject vehicle recognized in the recognizing, and
the generating an action plan including generating the action plan based on the traffic light information on the arrow-type traffic light generated in the generating a traffic light information, when there is, on the target path, an intersection installed the arrow-type traffic light on the target path.

6. A map generation method comprising:
generating a map, based on a data detected by an in-vehicle detection unit configured to detect a situation around a subject vehicle in traveling;
recognizing a traveling direction of the subject vehicle on the map generated in the generating a map; and
generating a traffic light information on a traffic light installed at an intersection as an additional information for the map generated in the generating a map, wherein
the traffic light is an arrow-type traffic light configured to permit traveling in a direction indicated by an arrow signal light, and
the generating a traffic light information includes generating the traffic light information, based on the direction indicated by the arrow signal light, detected by the detection unit, and the traveling direction of the subject vehicle recognized in the recognizing.
